(19) United States
(12) Patent Application Publication
(10) Pub. No.: US 2022/0145498 A1
(43) Pub. Date: May 12, 2022

(54) Fibre

(71) Applicant: THEUNSEEN LIMITED, London (GB)

(72) Inventors: Lauren Bowker, London (GB); Louise Anderson, London (GB); Samuel Dennis, London (GB)

(21) Appl. No.: 17/432,551

(22) PCT Filed: Feb. 21, 2020
(86) PCT No.: PCT/EP2020/054705

§ 371 Date: Aug. 20, 2021

(30) Foreign Application Priority Data
Feb. 21, 2019 (GB) 1902389.4

(51) Int. Cl. D01F 8/06; D01F 8/18; D01D 11/06; D01F 1/04; D01F 8/12; D01F 8/16; G02F 1/13

(52) U.S. Cl. CPC D01F 8/06; D01F 8/18; D01D 11/06; D01F 1/04; D10B 2401/04; D01F 8/16; G02F 1/132; D10B 2401/16; D01F 8/12

(57) ABSTRACT

A fibre comprising a core, a component, for example a liquid crystal, which is susceptible to a change in properties or structure in response to application of the external stimulus and an outer sheath is provided. The component is electrically conductive or adapted to undergo a structural change in response to the applied stimulus.

This invention relates to a fibre particularly to a fibre providing a desired function or aesthetic effect having a functional core which undergoes change upon application of an external stimulus. The invention relates especially to a fibre comprising an electrically conductive core such that the fibre provides a thermochromic effect. The fibre is useful in fabrics and personal care products, for example hair extensions.

Fibres which provide a functional and/or aesthetic effect such as fibres comprising a colour-change compound, sensor fibres and the like are known. Colour-change fibres typically comprise a colour-change material and undergo colour-change due to changes in the colour of the colour-change material on exposure to an external stimulus such as a change in temperature. Textile products and toys comprising a thermochromic material as a dispersed phase are known. Natural pigments and dyes, synthetic dyes, pigments, leuco dyes and liquid crystals have been used to provide colour to a substrate. Leuco dyes and liquid crystals may also provide a colour-change effect dependent on an outside stimulus such as light (photochromic), or heat (thermochromic). The colour-change material is typically applied to the surface of the fibre.

US2008/0279253 describes thermochromic garments which provide an indication of changes of body temperature. Sensor fibres are also known which may be responsive to an external stimulus and providing an indication of the presence of or change in the stimulus, for example thermally responsive wound dressings and temperature monitoring materials used in engineering and construction. Composite sensor fibres are described in U.S. Pat. No. 9,810,587.

Known fibres which provide a visual or functional effect do so typically in response to a changing environment, such as a change in temperature. We have found that novel functional and/or aesthetic effects may be provided in response to an external stimulus which is selectively applied by providing a fibre having a functional core which is responsive to an energy source or signal which is selectively applied to the core which then provides the desired functional and/or aesthetic effect to the fibre.

The invention provides in a first aspect a fibre comprising a core which is electrically conductive or adapted to undergo a structural change in response to an applied external stimulus which may be applied selectively, sheathed in an outer polymeric layer the fibre further comprising a responsive component interposed between the core and the outer polymeric layer or within the outer polymeric layer which responsive component is susceptible to a change in properties or structure in response to application of the external stimulus.

Advantageously, the functional or aesthetic effect may be initiated on a selective basis and controlled by the user as regards to the nature of the effect, the timing at which the effect is activated and the conditions under which the effect is activated. The effect may be a change in colour and the user may pre-select a range of colours to appear at specific pre-selected and a pre-programmed temperature. The effect may be controlled or tuned accurately according to pre-determined criteria or pre-programmed.

The term “functional” as employed herein means the provision of an effect which is aesthetic for example a change in colour or an effect which is provided by a structural change in a material which provides a change in a physical property, for example an increase in fluidity or rigidity or an effect due to both an aesthetic and a structural change.

Where the core is electrically conductive, selective application of electric current may be employed to provide a thermochromic effect due to the core heating on application of current. The fibre suitably comprises a thermochromic component disposed within the outer sheath or in a region interposed between the core and the outer sheath.

The component which is susceptible to a change in properties or structure in response to application of the external stimulus may comprise or be made from a component which undergoes a structural change upon selective application of an external stimulus.

In a preferred embodiment, the component comprises a colour change material, especially a liquid crystal. In another embodiment, the component comprises gallium and may consist essentially of gallium. Upon application of heat via the electrically-conductive core to a temperature in excess of 29° C., solid gallium melts whereby the fibre may be rigid at a temperature below 29° C. and flexible or malleable at a temperature in excess of 29° C. A fibre according to the invention comprising gallium may change its physical behaviour or form with temperature to provide a “shape-shifting” effect. This will enable an adaptive physical change from hard to malleable when the fibre is used within a fabric or garment. Any other material which undergoes a structural change as a result of temperature may be employed.

The fibre of the invention may be employed in any suitable applications to provide an aesthetic effect and are especially suitable for use as an artificial hair fibre or for forming a fabric.

The invention is particularly useful in providing a colour-adaptive fibre in which the fibre changes colour in response to a selectively applied electric current. We have found that by providing an electrically conductive core in a fibre and applying an electric current to the core, the core may be heated accurately to provide a precisely controlled thermochromic effect.

The invention provides in a second aspect a conductive fibre comprising an electrically-conductive core, an outer polymeric layer and a colour component wherein the colour component is within the outer polymeric layer and/or disposed in a region between the core and the outer polymeric layer, the colour component comprising a liquid crystal.

Advantageously, the present invention enables the pre-selection of a range of colours to appear at specific, pre-selected and pre-programmed temperatures. The user may then initiate provision of The external stimulus may be initiated by the user or may be provided by any other source, for example from an app or other data source to provide a predetermined signal or signal pattern to the core. The external stimulus may be an electrical current to heat the core or may comprise data signal or data stream to provide the requisite temperature change which correlates with the pre-selected colour-change. By providing variations in the external stimulus, the duration, colour, intensity or other variables of the fibre may be tailored as desired. The effect provided by the external stimulus is accordingly controlled by the user or a program, rather than simply being responsive to environmental or other uncontrolled external stimulus. The effect provided by the external stimulus may be controlled by or initiated from any suitable means including using a data stream or app which may be pre-programmed, for example using information relating to weather such as global weather patterns.

The fibre according to the invention provides an excellent combination of functional and/or aesthetic effects in combination whilst providing desirable physical characteristics including dimensional stability and “feel” for use as an artificial hair product or fabric. The aesthetic effect of the fibre may be tailored according to the desired application by employing a liquid crystal having the desired colour-change, or not changing colour, at temperatures which may be expected in the field of application. Other components may also be included with the liquid crystal to provide a particular aesthetic effect. The user accordingly is afforded a great deal of flexibility in tailoring the product to provide the desired aesthetic effect whilst the liquid crystal is protected by the hollow sheath and considerations of binding the liquid crystal to a substrate or fibre do not arise.

The term “feel” as employed herein refers to the sensory perception of the fibre including appearance/visual and tactile characteristics, for example tackiness, weight, width, movement of the fibre and the like in the context of its use. The feel of a fibre employed as artificial hair or artificial fur for example, will be different to the desired feel characteristics of a fibre employed in knitting a fabric.

When employed as an artificial hair fibre or fur, the “feel” of the fibre will be gauged against the “feel” characteristics of natural hair or fur, including how the fibre appears, for example the gloss and lustre of the fibre and the degree to which the fibre appears natural, the weight and width of the fibre and sensation to touch and tactility, not forming clumps, movement of the fibre and the like.

When employed in a fabric, the “feel” of the fibre refers to characteristics which are relevant to a fabric and desirably similar to a natural fabric, such as sensation to the touch, especially if worn against the skin, natural flexibility and the like.

The term “dimensional stability” as employed herein means the material maintains its original properties even when temperature, humidity, pressure or other changes in ambient conditions occur and the fibre retains its flexible characteristics.

The colour component may provide a colour-change or a fixed colour.

The electrically-conductive core is suitably connected to an electrical circuit or power source which provides a pre-determined and controllable current to the core enabling accurate heating of the core.

The structural change component is selected according to the desired effect and is disposed within the fibre such that it may provide the desired colour or structural change, at a precise temperature and after a pre-determined time. The user may select and modify the power input to the electrically-conductive core to provide a precisely tailored effect.

In one embodiment the fibre comprises an intermediate layer comprising the colour component between the electrically-conductive core and the outer polymeric layer. The intermediate layer may enclose part or the whole of the core so providing a barrier between the core and the outer polymeric layer.

The colour component may provide a fixed colour or a change in colour due to an applied external stimulus, for example a change in temperature, pressure or tension and electrical energy.

In a preferred embodiment, the colour component comprises a liquid crystal and colour is initiated by application of electric power to the core which thereby heats and provides the selectively applied stimulus which causes the colour to occur in a controlled way.

An encapsulated liquid crystal or an unencapsulated liquid crystal may be employed but an unencapsulated liquid crystal is preferred. The liquid crystal may be reversible such that it may pass from one state to another and return to the original state or irreversible in which case, it remains in the changed state and is not able to revert to its original state.

Liquid crystals comprise optically active organic chemicals which may be sealed or encapsulated, for example by microencapsulation, or unsealed for example in a poly-disperse form, as an oil. Liquid crystals may be encapsulated through a variety of means and materials and suitably comprises a known encapsulation material which is compatible with the liquid crystal such as a gelatin and gum arabic mixture, for example gum arabic and/or a gluteraldehyde cross-linked gelatin. Other encapsulate materials which are known or subsequently devised may be employed. Examples of other types of capsules include siloxane based capsules, thermoplastic polymer based capsules and thermoset polymer based capsules.

Suitable liquid crystals include cholesteric liquid crystals which are typically based on or comprise cholesterol or other sterol derived compounds including cholesteryl carbonate esters. Other suitable liquid crystals include non-sterol based compounds including chiral nematic liquid crystals, for example phenyl benzoate esters. Preferably, the liquid crystal consists of a chiral nematic liquid crystal, for example a phenyl benzoate ester or a combination of a chiral nematic liquid crystal as a major component and a cholesteric liquid crystal as a minor component.

Suitable liquid crystals are available from a range of sources including LCR Hallcrest. Non-cholesterol based liquid crystals such as phenyl benzoate esters provide bright, strong colour effects with high reflectance, suitable for premium products. Cholesteric-type liquid crystals typically provide colour effects which are less intense than non-cholesteric liquid crystals but are of lower cost and may be suited to larger volume markets. A mixture of non-cholesteric and cholesteric liquid crystals may be employed to optimise product performance and cost. In a preferred embodiment, the liquid crystal suitably comprises only non-cholesteric liquid crystals.

Liquid crystals show colour by selectively reflecting incident white light. Liquid crystals may reflect particular wavelengths of light according to an increase or decrease in the temperature from colourless to red through the other colours of the visible spectrum (red, orange, yellow, green, blue) in sequence and then colourless again at a higher temperature, known as the “clearing point”. The duration of each colour appearance can be tuned by altering the bandwidth to enable a specific colour to be observed for a prolonged period, also meaning that certain colours can be “deselected” in favour of others, for example red to blue, discounting green, creating a two-tone effect, or red, orange, yellow creating a tri-tone effect. When the liquid crystal is in its colourless state, the underlying colour of the core or other components in the fibre may be visible. Such colour changes are reversible such that on cooling the colour change occurs in reverse. The temperature at which commencement of colour change, referred to as the “starting point” or clearing point occurs and the temperature spread over which colour change occurs, referred to as the “bandwidth” may be tuned according to the composition of the liquid crystal.

The responsive component, preferably a colour component, comprises a liquid crystal, and optionally a dye and/or a pigment which is a fixed colour. The dye may be any colour, for example black, red or blue. In a preferred embodiment, the colour component comprises an oil soluble dye, carbon black, iron oxide, mica, graphite synthetic melanin and polydopamine pigment. Examples of suitable black dye or pigments include products available under the trade name MINISO. A dye and/or pigment may accordingly be selected according to the intended desired effect. A pigment may provide a more singular colour change.

In an especially preferred embodiment, the colour component further comprises a black component, for example an oil soluble black dye, carbon black and carbon nanotubes, available for example as VANTA BLACK.

In some embodiments, a “static” colour may be required. The term “static” as employed herein refers to a colour-change material which does not present a change in colour within the range of normal usage for the particular application. Thus while the colour component is capable of colour, it does not typically exhibit colour change under the conditions of use and shows a fixed colour. The colour component may comprise any material which presents a single colour in the conditions in which the composition is to be is used. A single colour may be provided by a colourant which does not change colour, for example a dye and/or a pigment or by a liquid colourant which is capable of colour change for example a liquid crystal or leuco colourant, but which colour change does not occur under the conditions of normal usage of the composition.

The colour component may comprise a static liquid crystal, and optionally a dye and/or a pigment which is a fixed colour. The dye may be black or blue, for example carbon black. In a preferred embodiment, the colourant comprises carbon black, iron oxide, mica, graphite synthetic melanin and polydopamine pigment. Examples of suitable black dye or pigments include products available under the trade name MINISO. A dye and/or pigment may accordingly be selected according to the intended desired effect. A pigment may provide a more singular colour change.

The term “singular” refers to a “two-tone” colour system, either a static colour or a marked colour change from colourless to coloured, or coloured to colourless, or from a first colour to a second colour, or a fluctuating colour between two colours as opposed to the traditional spectrum of colours, red, green and blue and transition between them typically observed with liquid crystal. For example a singular liquid crystal system may fluctuate between two colours such as green and blue without showing red. The term “singular” also refers to a single colour being observed above or below a certain pre-determined or tailored temperature.

In one embodiment, the colour change properties may be enhanced by combining a plurality of systems of liquid crystal within the same fibre, by mixing different liquid crystals, for example, combining a liquid crystal mixture that activates between 20 to 25° C. with a mixture that activates between 30 to 35° C. Advantageously, a fibre with multiple liquid crystals with different activation ranges allows multiple colour changes to occur within the same fibre, at different temperatures, providing a dynamic effect across a broader temperature range. In addition, multiple fibres containing different temperature responsive liquid crystals may be combined within the same fabric and interweaved so that they may be activated at different times.

In one embodiment the liquid crystal is dispersed in the polymer of the outer polymer layer. As the liquid crystal is in the outer layer, the colour effect is readily visible to an observer.

In another embodiment, the liquid crystal provides an intermediate layer and is interposed between the outer polymeric layer and the core. Where the liquid crystal is unencapsulated, the outer polymeric layer may act to retain the liquid crystal in place, interposed between the outer polymeric layer and the core. The outer polymeric layer is suitably selected such that changes in colour of the intermediate liquid crystal layer provide the desired visual effect to the observer and may be transparent or translucent.

The electrically-conductive core may be metal or a non-conductive material coated, doped or otherwise comprising a conductive material, for example graphite. Preferably the core is malleable and extrudable to aid manufacture. Examples of suitable metals include steel, aluminium and copper. Preferably, the electrically-conductive core has a high resistance so as to be capable of delivering a higher level of thermal energy to the fibre with low resistivity.

The core may comprise a single filament of electrically conductive material or may comprise a plurality of filaments entwined together or separately to enable a higher current or heating capacity to be provided.

The electrically-conductive core may be selected to have a particular colour or may be dyed or coated in a material to provide a desired colour which contributes to the colour effect. In one embodiment, the core has a black surface or is dyed or coated to provide a black surface to reflect light and enhance the vibrancy of the colour of the overlying liquid crystal.

Suitably, the core material has good conductive properties and a high resistance to provide rapid, consistent and stable heating and a flexibility rendering it suitable for use in a fibre for knitting or weaving into a fabric. The core may comprise multiple filaments rather than a single core to provide improved flexibility. Examples of a suitable core material include stainless steel multifilament available under the trade name BEKINOX VN from Bekaert. The core suitably has an “S”-type twist to aid gripping to the polymer sheath and aid processing.

In addition to the core, the fibre may further comprise a stabilisation filament within the fibre. The stabilisation filament may be any elongate natural or synthetic material for example cotton, carbon, nylon and extrudable polymers or the like. The filament is suitably fed into an extruder feed together with the core. The stabilisation filament suitably stabilises the formation of the fibre, particularly at larger scales, enabling an increased speed of extrusion of the polymer sheath, responsive component and the core. The stabilisation filament aids the core in gripping the polymer sheath as it is formed. The stabilisation filament may be coloured, for example be black, blue or red, so as to provide an enhanced colour effect with the responsive component.

The outer polymeric layer acts as a sheath for the core and the component between the core and the outer layer. The component which is susceptible to a change in structure or properties upon application of the external stimulus for example a colour component, may be present within the outer polymeric layer or disposed in a region between the outer polymeric layer and the core.

The outer polymeric layer suitably comprises a polymer which is suitably melt flowable and exhibits good flexibility in an undrawn state. The material suitably also is clear and desirably translucent or transparent to facilitate observance of the desired effect, for example colour change. The outer polymeric layer is also suitably resistant to physical wear and abrasion especially where the fibre is employed in making a fabric, to provide resilience in a typical knitting process to preserve the appearance of the fibres and to protect the internal components of the fibre from physical damage or, in the case of unencapsulated liquid crystal, from rupture and leakage. Desirably, the polymer is also resistant to stress-whitening in the knitting process. Suitably, the polymer is selected to obtain a non-tacky finish to allow for it to be used in standard knitting processes without sticking to itself or production apparatus.

Suitably, the outer polymeric sheath comprises a polymer which is immiscible or at most partially miscible with the liquid crystal and may be selected from a wide range of polymers including poly olefins, polyethylene terephthalate, nylon, modacrylic, that is any thermoplastic polymer modified with from about 35 to 85% of acrylonitrile units, thermoplastic polyurethanes for example the ELASTOLLAN range from BASF, thermoplastic elastomers, for example the AFFINITY range from Dow, thermoplastic olefins, for example EPDM, polyesters, polyethylene, polypropylene, thermoplastic vulcanizate, for example SANTOPRENE from Exxon,

Suitably, the polymer is selected from a polyolefin, a polyurethane, polyethylene terephthalate, nylon and modacrylic. Suitable, polyurethanes include ether based polyurethanes and, preferably ester based polyurethanes, for example ELASTOLLAN 1180 Other polymers may be employed but are less preferred. Examples of suitable polymers include polyurethane available under the trade name ELASTOLLAN B85A 1000 from BASF and NYLON 6 NATURAL BS10 available from Schulman.

In a preferred embodiment, the polymer sheath comprises a polyolefin, more preferably, polyethylene, polybutylene and polypropylene. The polymer sheath may comprise a copolymer, preferably a thermoplastic elastomer suitable for polymer modification, more preferably a copolymer of 2 or more alkenes, especially a copolymer of a 1 to 4 carbon alkene and a 6 to 10 carbon alkene, for example ethylene-1-octene, available under the trade name LUCENE from LG Chem, for example LUCENE LC670 and isotactic polypropylene, for example VISTAMAXX 6202 available from ExxonMobil. In a preferred embodiment, the polymer sheath consists of solely polypropylene or comprises from 50 to 99%, 60 to 90% and especially 70 to 85% polypropylene and from 1 to 50%, 10 to 40% and especially 15 to 30% of a thermoplastic elastomer, preferably a copolymer of two olefins, especially ethylene-1-octene.

The fibre may comprise one or more additional components in the colour component within the cavity of the sheath and/or within the polymeric sheath. In one embodiment, additional components include one or more further colour components. If used within the cavity, the further colour component preferably comprises a dye which may be oil-based or a powder pigment, especially a dark colour component, for example carbon black, carbon nano tubes, such as VANTA BLACK. For inclusion within the polymeric sheath, the additional colour component may be a powder pigment or dispersion of a pigment, for example an inorganic powder pigment but is preferably an oil soluble dye, for example a red dye and a black dye. Examples of suitable dyes include SUDAN Black B and SUDAN III. Suitably the further colour component is employed at a level of 0.1 to 3%, and especially from 0.2 to 0.6%.

If an encapsulated liquid crystal is present in the cavity or the outer sheath, any additional colour component will be water-based to avoid compromising the encapsulation of the liquid crystal. Where an unencapsulated liquid crystal is employed, the dye is suitably comprises an oil soluble dye, preferably a black oil soluble dye or a red oil soluble dye. Where an encapsulated liquid crystal is employed, an oil soluble dye may be employed within the encapsulate, intimately mixed with the encapsulated liquid crystal. If a soluble dye is employed outside of the encapsulate, such a dye should be water soluble so as to reduce the risk of adverse interaction with the encapsulating material

Further optional components that may be included within the cavity of the sheath and/or in the polymeric sheath alone or in combination itself include a component which undergoes a solid liquid phase change at a temperature under 50° C., to provide a change in rigidity between being flexible when warm and solid when cool, for example gallium, wax to provide opacity and structural change due to a change in temperature, typically being translucent and flexible when warm and opaque and hard when cold.

The fibre may further comprise a further colour component in the outer sheath. The colourant is suitably a fixed colour which enables or enhances visual appearance or enhancement of the properties of the liquid crystal. The colourant may be any colour for example red, orange, yellow, green, blue, indigo, violet, brown and black. Lighter colours may offer a pearlescent or opalescent effect. The colourant may be incorporated into the polymer sheath as a powder at any desired level. Examples of suitable colourants include the Sicopal®, Magnapearl® DF Series, Eupolen®, Micranyl®, Microlen® ranges available from BASF. The outer sheath may comprise a leuco dye, which may be reversible or irreversible as regards colour-change.

The fibre composition may further comprise a UV stabiliser. Liquid crystals may be prone to degradation due to the impact of UV radiation. Any known approved UV stabilisers that are compatible with the system may be employed. Preferred UV stabilisers include UVA stabilisers such as Tinuvin® from BASF, Benzophenone-4, Avobenzone, Homosalate, Octocrylene, Benzophenone-5, Ethylhexyl Dimethyl PABA, Titanium oxide, Zinc oxide, Phenylbenzimidazole sulfonic acid, PEG-25 PABA, disodium phenyl dibenzimidazole tetrasulfonate.

The polymer sheath may contain other additives. Examples of suitable additives include additives to provide biodegradability and antibacterial characteristics, for example silver, suitably as nanoparticles. Suitably UV stabilisers and other additives are employed in conventional amounts, typically from 0.1 to 5% by weight of the polymer sheath.

The fibre suitably provides a yarn which may be used as a single yarn as a hair extension or other hair product or to provide an artificial fur or a fabric, for example a knitted fabric. Fibres or fabric according to the invention may be in the form of a knitted fabric, woven tassle, embroidered, crochet, a wig-extensions, hair extension, artificial fur, toys, dolls, brushes and colour boards where samples of artificial hair may be displayed to illustrate effects.

The invention provides in a further aspect, a fabric comprising a multitude of fibres according to the invention interlinked, for example by weaving or knitting. The monofilament fibre may also be used in bulk to create a multifilament yarn, by entwining several monofilament fibres together. The fibre or yarn may also be used as a mono or multi filament for fine detail embroidery of patterns or designs onto existing clothing or fabric by hand or by machinery.

The thickness of the fibre or yarn, traditionally referred to as the yarn weight, can be tuned for specific applications by modifying the drawing process during extrusion of the fibre or yarn whereby increasing the draw reduces the thickness of the fibre or yarn. The electrically conductive core can also be selected for this purpose, whereby use of a thicker electrically conductive core will enable an overall heavier weight fibre or yarn to be created. The fibre or yarn weight can range from 0.1 ply to 16 ply therefore enabling a variety of fabric applications ranging from embroidery to chunky knit. Some example yarn weights (ply) and knit application are given in Table 1.

TABLE 1

| Name | Ply (UK, NZ, AU) | Knit Application |
|---|---|---|
| Cobweb | 1 ply | Lace |
| Lace | 2 ply | Lace |
| Light fingering | 3 ply | Lace |
| Fingering | 4 ply | Super fine |
| Sport | 5 ply | Fine |
| DK | 8 ply | Light |
| Worsted | 10 ply | Medium |
| Aran | 10 ply | Medium |
| Bulky | 12 ply | Bulky |

The fibre is suitably adapted to provide an effect as required by the user, for example transparent to opaque, matt to shiny, reversible colour-change and irreversible colour-change.

The fabric suitably complies with any applicable regulations or industry standards in the field in which the fabric or fibre is being employed, for example weight requirements for performance fabrics, wash-fastness, rub-fastness, UV-fastness and regulations in the automotive, airline and other travel industries where fibres and fabrics of the present invention may be employed.

Suitably, the fibre has a light fastness which meets the criteria set out in ISO 105-B02:2014. As desired, the fibre may comprise a known UV absorber, preferably within the outer polymeric layer.

The fibre or a fabric produced from the fibre is suitably resistant to abrasion and meets the criteria set out in ISO 12947-2:2016.

Where the fibre is knitted or woven into a fabric, the yarn preferably provides suitable twist and recovery when tension is released to determine if it is suitable for knitting.

The invention provides in a further aspect a method of controlling an observable change in appearance of a fibre or yarn according to the invention which comprises providing an input representative of a pre-determined appearance of the fibre or fabric to a source of an external stimulus to generate an applied external stimulus, the applied external stimulus being conveyed to the core of the fibre so generate a change in structure or properties of a component in the fibre.

The applied external stimulus may be controllable by the user using an app or other product which is communicable with the energy source providing the applied external stimulus to provide an electrical current or structural change in the core. For example an effect may be initiated by a user via an app to provide, at a chosen time and/or in response to pre-selected external conditions, an energy input to the electrically-conductiver so as to initiate a structural change or current to the core so as to provide a change in colour.

Suitably, the input is provided by an app which communicates with the source of the external stimulus to generate the stimulus. Suitably the stimulus is in the form of an electric current and current is passed through the core of the fibre. The component in the fibre which is susceptible to structural change or a change in properties is suitably a colour component and especially a colour change component. Preferably, the colour-change component comprises a thermochromic component, for example a liquid crystal.

The fibre may be incorporated in an article or a fabric as a component part of the whole or as a “patch” as a discrete area of the fabric, for example a knitted yarn or article. Suitably, the fibre, fabric or an article comprising the fibre or fabric comprises a controller adapted to receive an external stimulus, for example a data stream or electric current. Preferably the controller comprises an electronic circuit board and is adapted to provide a stimulus or signal to the fibre which is generated in response to an input to the circuit board from a direct input or data stream, for example from an app.

In a further aspect, the invention provides a colour change fibre, fabric or article comprising a controller adapted to receive an input and a fibre or series of fibres according to the invention which is/are operably connected to the controller so as to provide a change in properties or structure of the fibre or series of fibres in response to the said input.

The invention further comprises an article, for example an item of apparel, clothing, footwear or the like, comprising a surface patch comprising a colour change fibre or fabric comprising a controller adapted to receive an input and a fibre or series of fibres according to the invention which is/are operably connected to the controller so as to provide a change in properties or structure of the fibre or series of fibres in response to the said input and thereby change the appearance of the article

The external power source may be a portable energy source for example a battery and is suitably operably linked to the electrically-conductive core. Preferably, the power source is a battery or series of batteries and is as compact and light as possible. The power source is preferably incorporated into the fabric or other product as discreetly as possible. Current battery systems, typically having a voltage of 3 to 4.5 V, may be employed for wearable fabrics, apparel, shoes and fibres, although batteries with lower or higher voltage requirements may be used. In other applications, for example the use of a fabric in an automotive or other travel seat context, the battery suitably has a power of 5 to 24V. Optionally the energy source may also come from a renewable source, such as through solar energy or kinetic energy harvesting.

The electrically-conductive core is suitably connectable to an electrical circuit such that power passing into the core is controllable to provide fine control over the heating of the fibre. The power provided and the corresponding temperature change are suitably calibrated with the pre-determined colour shifts or changes thereby affording the user the opportunity to tailor the observed colour-change.

In a preferred embodiment, the controller comprises a power supply, for example a 24V supply, and a control system. The power supply is suitably used to deliver power to the fibre or patch in order to generate heat to initiate colour. Suitably, the control system monitors the temperature of the fibre or patch, for example using a thermistor or thermocouple, and maintains a specific temperature in the patch through pulse width modulation (PWM).

Any control method may be employed but is preferably the proportional integral derivative (PID) method, involving the setting of a specific target temperature and then pulsing power to the patch in order to allow precise control. Errors in the temperature attained are then measured and recorded by the control system, and the output adjusted by increasing or decreasing the length of the pulses in the PWM signal.

In a preferred embodiment, the patch or fibre is excited via Joule heating such that the temperature of the core is raised to cause the thermochromic compound in the fibres to modulate light hitting their surface, producing a shift in visible colour.

Optimally, the patch has a resistance from 90 to 150 ohms, Suitably, the maximum current applied to the core is about 150 mA enabling the patch to heat and stimulate a visual change within 30 seconds.

In a further aspect, the invention provides a process for the production of a fibre according to the invention which comprises feeding an electrically-conductive core and a responsive component, preferably a liquid crystal into a first channel having an outlet, feeding a polymer melt into a second channel and extruding the polymer melt through the second channel and out of a die nozzle, the second channel being coaxial with and of greater diameter than the first channel and wherein the outlet of the first channel is at the same position or extends beyond the die nozzle, whereby the polymer is extruded to form a sheathe around the first channel and to entrap the responsive component around the core as it emerges from the first outlet thereby to form a fibre according to the invention.

Preferably, the polymer melt is extruded through a “spider” die which facilitates a more even flow of the melt and provides a more stable fibre.

Application of the applied external stimulus may be initiated by a sensor detecting a certain condition, for example temperature, level of sunlight, proximity of a mammal, for example a person to the sensor and an electrical current being provided to the electrically conducting core.

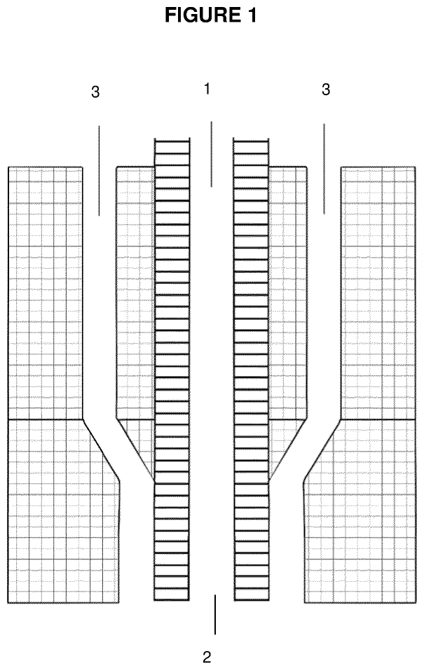

Suitably, a fibre of the invention is produced by extrusion with a wire coating die, preferably a “spider” die as illustrated in FIG. 1. Liquid crystal and optionally other components are mixed together and tailored according to the desired colour effect. The core and liquid crystal are passed through channel 1 (Feed A) and out of the die nozzle 2 such that the liquid crystal forms a layer around the core. A polymer melt for forming the outer polymeric sheath is passed though outer concentric channel 3 (Feed B) and forms a coating around the core and liquid crystal prior to the exit from the die nozzle 2 so as to form a sheath around the liquid crystal and entrap the liquid crystal in a layer intermediate between the outer polymeric layer and the core. The channel 1 suitably extends beyond the exit of nozzle 2 such that the liquid crystal may flow into the cavity within the formed outer sheath and the core rather than the outer polymer forming directly around the core. Suitably, the formed fibre is carefully withdrawn by attachment to a winder at a controlled speed. By varying the speed of the winder, the thickness of the outer sheath may be adjusted to the desired thickness.

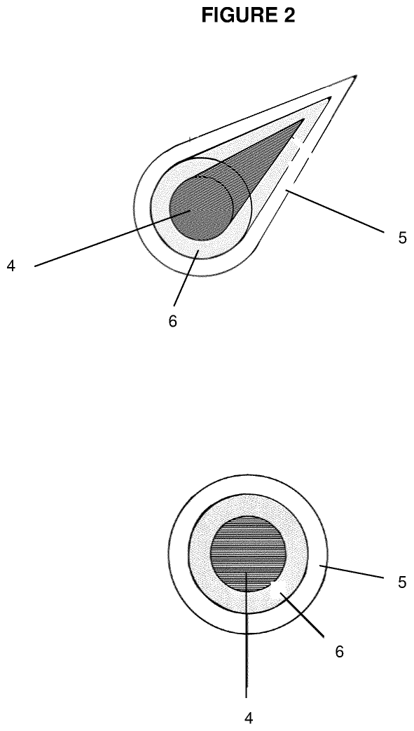

FIG. 2 shows a schematic representation in cross section and in perspective view of a fibre according to the invention having an electrically-conductive core 4, an outer polymeric layer 5 which provides a sheath for retention of the functional or aesthetic component 6.

The invention is illustrated by the following non-limiting examples. All percentages and parts are parts by weight and all measurements made are at 25° C., unless otherwise stated.

### EXAMPLES

Fibres according to the invention were prepared by passing a core through a dye with an outer coaxial zone for passage of the outer polymeric sheath and an intermediate concentric channel for passage of the liquid crystal. The outer polymeric layer enclosed the liquid crystal around the core to produce a fibre according to the invention.

Fibres having the components listed in Table 2 were prepared. Where the intermediate layer or outer layer comprised additional components to the liquid crystal or polymer respectively, the respective components we pre-mixed with the main component of the layer. The outer polymer was extruded at a draw speed of between 30 and 60 rpm and with an inlet/middle/outlet barrel temperature of 240-320/240-260/250-260. The middle layer was introduce manually.

TABLE 2

| Example | Component | Ingredient | Component | Source | Concentration (%) |
|---|---|---|---|---|---|
| 1 | Core | Stainless Steel multifilament | Bekinox VN | Bekaert | 100 |
| | Middle layer | thermochromic liquid crystal | | LCR hallcrest | 99 |
| | | carbon black | EMPEROR 1200 | Cabot | 1 |
| | Outer | Polyurethane | Elastollan B 85A | BASF | 100 |
| 2 | Core | Stainless Steel multifilament | Bekinox VN | Bekaert | 100 |
| | Middle layer | thermochromic liquid crystal | | LCR hallcrest | 99 |
| | | carbon black | EMPEROR 1200 | Cabot | 1 |
| | Outer sheath | Nylon 6 | Nylon 6 Natural | A. Schulman | 100 |
| | | | BS10 | | |
| 3 | Core | Stainless Steel multifilament | Bekinox VN | Bekaert | 100 |
| | Middle layer | thermochromic liquid crystal | | LCR hallcrest | 99 |
| | | carbon black | EMPEROR 1200 | Cabot | 1 |
| | Outer sheath | Polyurethane | Elastollan B 85A | BASF | 99 |
| | | | 1000 | | |
| | | UV Absorber | Tinuvin 99-2 | BASF | 1 |
| 4 | Core | Stainless Steel multifilament | Bekinox VN | Bekaert | 100 |
| | Middle layer | thermochromic liquid crystal | | LCR hallcrest | 100 |
| | Outer sheath | Nylon 6 | Nylon 6 Natural | A. Schulman | 98.5 |
| | | | BS10 | | |
| | | UV Absorber | Tinuvin 99-2 | BASF | 1 |
| | | Colourant | Heliogen ® Blue | BASF | 0.5 |
| | | | D 70 | | |
| 5 | Core | Stainless steel multifilament | BekinoxVN | Bekaert | 100 |
| | Middle layer | Phenyl benzoate | | LCR hallcrest | 100 |
| | | ester liquid crystal | | | |
| | Outer sheath | Polypropylene 25 MFI | | | 100 |
| 6 | Core | Stainless steel multifilament | BekinoxVN | Bekaert | 100 |
| | Middle layer | Phenyl benzoate | | LCR hallcrest | 100 |
| | | ester liquid crystal | | | |
| | | (75) and cholesteric | | | |
| | | liquid crystal (25%) | | | |
| | Outer sheath | Polypropylene 25 MFI | | | 100 |
| 7 | Core | Stainless steel multifilament | BekinoxVN | Bekaert | 100 |
| | Middle layer | Phenyl benzoate | | LCR hallcrest | 100 |
| | | ester liquid crystal | | | |
| | Outer sheath | Polypropylene 25 MFI (80%) | | | 100 |
| | | and LUCENE LC670 (20%) | | | |
| 8 | Core | Stainless steel multifilament | BekinoxVN | Bekaert | 100 |
| | Middle layer | Phenyl benzoate | | LCR hallcrest | 100 |
| | | ester liquid crystal | | | |
| | Outer sheath | Polypropylene 25 MFI (80%) | | | 100 |
| | | and LUCENE LC670 (20%) | | | |
| 9 | Core | Stainless steel multifilament | BekinoxVN | Bekaert | 100 |
| | Middle layer | Phenyl benzoate | | LCR hallcrest | 100 |
| | | ester liquid crystal | | | |
| | | (75) and cholesteric | | | |
| | | liquid crystal (25%) | | | |
| | Outer sheath | Polypropylene 25 MFI (80%) | | | 97 |
| | | and LUCENE LC670 (20%) | | | |
| | | CESA light stabiliser | | | 3% |
| 10 | Core | Stainless steel multifilament | BekinoxVN | Bekaert | 100 |
| | Middle layer | Phenyl benzoate | | LCR hallcrest | 100 |
| | | ester liquid crystal | | | |
| | | (75) and cholesteric | | | |
| | | liquid crystal (25%) | | | |
| | Outer sheath | Polypropylene 25 MFI (80%) | | | 97 |
| | | and VISTAMAXX6202 (20%) | | | |
| | | (ExxonMobil) | | | |
| | | CESA light stabiliser | | | 3% |

The fibres were produced by extruding the polymer around the core while introducing the liquid crystal middle component. All fibres were adequately formed and flexible with even coating of the liquid crystal on the core and were suitable for processing into a yarn and weaving into a fabric.

On application of an electric stimulus to the core for each example, the core reached a temperature of at least 35° C. and stimulated the liquid crystal to change colour. Those examples containing solely nematic liquid crystal provided the greater vibrancy and intensity of colour change.

Example 6 to 10 were repeated including an oil soluble dye in the liquid crystal. The dye provided enhanced brightness of colour

1. A fibre comprising a core which is electrically conductive and adapted to selectively receive electric current to heat the core such that the fibre provides a thermochromic effect or undergoes a structural change, the core being sheathed in an outer polymeric layer the fibre further comprising a responsive component interposed between the core and the outer polymeric layer or within the outer polymeric layer which responsive component is susceptible to a change in properties or structure in response to application of the electric current.

2. (canceled)

3. A fibre according to claim 1 wherein the responsive component comprises a colour component within the outer polymeric layer and/or disposed in a region between the core and the outer polymeric layer

4. A fibre according to claim 3 wherein the colour component comprises a liquid crystal.

5. A fibre according to claim 3 wherein the colour component comprises a liquid crystal and colour is initiated by application of electric power to the core which thereby heats and provides a selectively applied stimulus to prompt colour-change.

6. A fibre according to claim 3 wherein the liquid crystal comprises an unencapsulated liquid disposed between the core and the outer layer.

7. A fibre according to claim 3 wherein the liquid crystal is encapsulated and dispersed in the outer polymeric layer.

8. (canceled)

9. A fibre according to claim 1 wherein the electrically conductive core comprises a metal selected from a steel, aluminium or copper wire.

10. A fibre according to claim 1 wherein the electrically conductive core has a pre-selected colour whereby the colour contributes to the visual appearance of the colour-change fibre.

11. A fibre according to claim 1 wherein the outer polymeric layer is transparent or translucent whereby the liquid crystal is visible.

12. (canceled)

13. A fibre according to claim 1 wherein the outer polymeric layer is selected from nylon, modacrylic, polyamide, polyester, polyethylene terephthalate, polyalkylene, a thermoplastic vulcanizate, a thermoplastic polyurethane a thermoplastic elastomer polymer, a synthetic rubber and a thermoplastic olefin.

14. A fibre according to claim 1 wherein the outer polymeric layer comprises a colourant.

15. A fibre according to claim 1 wherein the outer polymeric layer is substantially free of components which impair the visual effect of the liquid crystal.

16. A fibre according to claim 1 further comprising a colourant dispersed or dissolved in the outer layer or a colourant layer disposed between the core and the outer layer.

17. A fibre according to claim 16 wherein the colourant is black and is mixed with the liquid crystal.

18. A fabric comprising a multitude of interlinked fibres, the fibers each comprising a core which is electrically conductive and adapted to selectively receive electric current to heat the core such that each fibre provides a thermochromic effect or undergoes a structural change, the core being sheathed in an outer polymeric layer, the fibres each further comprising a responsive component interposed between the core and the outer polymeric layer or within the outer polymeric layer which responsive component is susceptible to a change in properties or structure in response to application of the electric current.

19. (canceled)

20. A fabric according to claim 18 wherein the fibres are arranged to present a predetermined image in the fabric.

21. A fabric product comprising a fabric, the fabric comprising a multitude of interlinked fibres, the fibres each comprising a core which is electrically conductive and adapted to selectively receive electric current to heat the core such that each fibre provides a thermochromic effect or undergoes a structural change, the core being sheathed in an outer polymeric layer, the fibres each further comprising a responsive component interposed between the core and the outer polymeric layer or within the outer polymeric layer which responsive component is susceptible to a change in properties or structure in response to application of the electric current, the fabric product also including means to provide electrical power to the core.

22. (canceled)

23. (canceled)

24. A process for the production of a fibre, the fibre comprising a core which is electrically conductive and adapted to selectively receive electric current to heat the core such that the fibre provides a thermochromic effect or undergoes a structural change, the core being sheathed in an outer polymeric layer, the fibre further comprising a responsive component interposed between the core and the outer polymeric layer or within the outer polymeric layer which responsive component is susceptible to a change in properties or structure in response to application of the electric current, the process comprising: feeding the electrically-conductive core and a component selected from a liquid crystal and a component which is susceptible to a change in properties or structure in response to application of heat into a first channel having an outlet, feeding a polymer melt into a second channel and extruding the polymer melt through the channel and out of a die nozzle, the second channel being coaxial with and of greater diameter than the first channel and wherein the outlet of the first channel is at the same position or extends beyond the die nozzle, whereby the polymer is extruded to form a sheathe around the first channel and to entrap the component around the core as it emerges from the first outlet thereby forming the fibre.

25. A method of providing at least one of a colour-change effect and a structural change in at least one of a fibre or a fabric comprising an interlinked multitude of the fibre, the fibre comprising a core which is electrically conductive and adapted to selectively receive electric current to heat the core such that the fibre provides a thermochromic effect or undergoes a structural change, the core being sheathed in an outer polymeric layer, the fibre further comprising a responsive component interposed between the core and the outer polymeric layer or within the outer polymeric layer which responsive component is susceptible to a change in properties or structure in response to application of the electric current, the method including providing an external stimulus to the conductive core so as to cause it to change temperature and thereby cause the responsive component to change at least one of its visual appearance and structure.

26. A method according to claim 25 wherein the external stimulus is controllable by a user using an app or a data stream which is communicable with an energy source configured to provide the external stimulus which provides an electrical current or structural change in the core.
